(19) United States
(12) Patent Application Publication
(10) Pub. No.: US 2020/0061832 A1
(43) Pub. Date: Feb. 27, 2020

(54) DRIVE SYSTEM AND ASSESSMENT THEREOF

(71) Applicant: Siemens Aktiengesellschaft, 80333 München (DE)

(72) Inventors: Jochen Bretschneider, Esslingen (DE); MAXIMILIAN KLAUS, Gerlingen (DE); DAVID BITTEROLF, Erlangen (DE); CARSTEN HAMM, Eggolsheim (DE); THEO REICHEL, Forchheim (DE)

(73) Assignee: Siemens Aktiengesellschaft, 80333 München (DE)

(21) Appl. No.: 16/489,263

(22) PCT Filed: Feb. 26, 2018
(86) PCT No.: PCT/EP2018/054643

§ 371 Date: Aug. 27, 2019

(30) Foreign Application Priority Data
Feb. 28, 2017 (EP) 17158480.8

(51) Int. Cl. B25J 9/16; G05B 19/4155

(52) U.S. Cl. CPC B25J 9/1671; G05B 2219/32398; G05B 19/4155

(57) ABSTRACT

The invention relates to a method for the assessment of a drive system (22) of a machine tool (21) or of a production machine (21), the drive system (22) having an axis (23, 24, 25), wherein a load of the drive system (22) is simulated, a drive profile (20) being used for simulation, actual values of the drive system (22) being simulated, the simulated actual values (40) being correlated with comparative values (41). The drive system (22) has at least one axis (23, 24, 25), a simulated load of the drive system (22) being correlated with at least one comparative value (41) on the basis of a drive profile (20).

The invention relates to a drive system, in particular that of a machine tool, of a robot or of a production machine, and to a method for the assessment of the drive system.

The operation of a machine, such as a machine tool, a production machine or a robot, is subject to various general conditions. Depending on those conditions, a load on the machine (e.g.: a lathe, milling machine, grinding machine, drill, robot, etc.) is produced. In order to machine a workpiece using a machine tool, a part program is executed in a controller of the machine tool, for example, which controls the motion sequences of a tool in particular with pinpoint accuracy. The part program comprises a large number of program instructions that can trigger various actions by the controller or machine tool. For example, there are program instructions that directly effect a relative movement of the tool vis-à-vis the workpiece along a predetermined path with pinpoint accuracy. However there are also program instructions that call a subprogram, an auxiliary movement, or a cycle, for example. In these latter cases, parameters, by means of which a machining process or a movement to be executed by the machine tool is specified more precisely, are generally transferred as well. For example, parameters are provided to the controller by the part program when a pocket milling cycle is called, which determine the exact position and size of the pocket to be milled. The program instruction “mill pocket” in conjunction with the corresponding parameters causes the controller automatically to generate the necessary path data for the movement of the tool relative to the workpiece. Calling an auxiliary movement is another example of a program instruction. Here, only the start and end point are specified to the controller, and the controller generates corresponding path data for the auxiliary movement so that the tool not engaging with the workpiece is moved in a collision-free manner from the start point to the end point.

In series production it can be important for the motion sequences executed by the machine tool to be optimized, since non-optimized motion sequences can represent a significant time and therefore cost factor in the manufacture of a workpiece. In order to raise machine productivity, it can therefore be worthwhile—especially in series production—to use optimized motion sequences, or to optimize the load on hardware. Hardware refers to the drive system, for example. The machine's axes can represent part of the hardware, for example. An axis has for example an electric motor and/or a current converter. The calculation of optimized motion sequences takes place offline, for example, i.e. outside of the controller, as this requires a large amount of computing power and is very time-consuming. In this approach, changes to the part program carried out directly on the machine can be integrated into the optimization of motion sequences only with difficulty. This represents an impediment to the generation of time-optimized motion sequences and usually restricts their use to large-scale series production.

In a simplified approach, motors or drives can be dimensioned by specifying a load change. Here, the dimensioning of the motor, the mains power supply, the power modules, the regulation components and/or the position detection function is performed on the basis of the required torque, the required rotational speed and/or the required power.

The dimensioning of the motor is performed for example with regard to:
Mmax maximum torque
Imax maximum current (basis: moved mass and desired acceleration amax)
Mnenn rated torque
Nmax maximum rotational speed
I2t thermal overload of the motor/actuator) and/or
S1, S2, S3 standardized operating mode

The variables drawn upon, especially masses and rated power, depend to a very large extent on the design of the machine and are perhaps not yet known at the time of motor configuration. The dimensioning is therefore then based on assumptions by the customer, for example, and involves safety factors.

A simulation tool and an analysis tool for a mechatronic system are known from US 2010/0082314 A1. The behavior of a drive system can be predicted on the basis of a configuration by a user.

A dimensioning program can be used to dimension a drive, which can have a combination of a motor and current converter, for example.

The dimensioning of one or more drives then becomes complex in particular if multi-axis machines are involved, as may be the case for example with machine tools and robots, if the movement of one axis changes the position of another axis. A mechanical interaction between the axes is then produced.

In some cases the data about motor/drive dimensioning is imprecise. This affects the dimensioning of applications with linear and torque motors, for example. However the limits of feasibility for an application may have to be approached with these direct drives in particular. In the past, motors or drives were often overdimensioned unnecessarily (safety margin). This situation can be improved through a better dimensioning method. In this way, the following problems can be overcome, by way of examples:
The acceleration configured for a machine is not achieved for a typical customer application because the jerk limited by the mechanics of the machine does not allow this;
The drives are overheated in a particular customer program;
An application is not realized because the general dimensioning provides incorrect predictions and/or
In the case of questions that relate to the machine's mechanics, movement control and drive dimensioning in general, customers can be supported only inadequately.

An object of the invention is to improve the drive system of a machine. The dimensioning of the motor and/or of a downstream component can then be made more precise. In this way, incorrect dimensioning can be avoided in particular. This refers to e.g. overdimensioning of the drive or underdimensioning of the drive.

One solution to this object is provided in accordance with a method having the features as claimed in claim 1 and with a drive system having the features as claimed in claim 14. Further embodiments are provided in accordance with claims 2 to 13 and 15 to 17, by way of examples.

In a method for the assessment of a drive system of a machine tool or of a production machine, the drive system having an axis, a load of the drive system is simulated. The drive system has in particular three or more axes. A drive profile is used for the simulation, wherein actual values of the drive system are simulated, wherein the simulated actual values are correlated with comparative values. The load can be determined or calculated for example on the basis of a maximum torque Mmax, a maximum current Imax, a rated torque Mnenn, a maximum rotational speed Nmax, a thermal load I2t and/or a standardized operating mode such as S1, S2, S3, etc. In this way, during the operation and/or development of a machine for example, the load of the machine axes (axes) can be determined and/or optimized, for example. This refers in particular to a given application that could be optimized. In particular, the optimization is performed automatically.

In one embodiment of the method the drive profile is based on a part program. The part program is known for example from the programming of machine tools.

In one embodiment of the method, the part program is traveled along in order to determine the load in a machine with a part program, and using measurement data it is checked whether the machine is producing the dynamics set. If the desired machining time is not achieved, then the dynamics requirement is gradually increased. In this way, either the target is achieved, or the drives' limits are reached (e.g. current, torque, power, rotational speed). This then allows a limiting component to be determined and replaced with a higher-powered component, for example.

In one embodiment of the method a virtual machine is used. This virtual machine has components such as a numerical controller (NC), a drive and a machine model, for example. These components can be simulated in three successive stages, for example:
NC (with ideal drives and ideal mechanics)
NC+drives (and ideal mechanics)
NC+drives+FE model (finite elements model)

This simulation can be carried out for customer applications as part of a virtual production using a mechatronic model of the machine. Added to this is the application for motor/drive dimensioning. Detailed conclusions can be reached regarding the motor dimensioning, especially in combination with a particular NC program or motion sequence for the customer. Here, the specific characteristics of the algorithms for motion control in the NC and the regulated drives are considered. This then allows dynamic and thermal aspects to be examined. During dimensioning, the customer's specific application is already examined by means of the virtual machine. The motor load is calculated for the typical application, for example, and not for a theoretical load cycle alone. Through simulation with a virtual machine in different configurations as well, the dimensioning of the motor/regulated drive is refined in respect of static, dynamic and thermal aspects. A virtual production can be drawn upon for the motor/drive dimensioning.

In one embodiment of the method the drive system has at least five axes. In machine tools that allow five-axis machining, the interaction of the different axes while also taking account of various part programs is complex, and consequently advance processing of the drive system allows it to be improved. So, for example, before the construction of the machine tool or a robot or a production machine, with a large number of axes the mechanics of the machine tool or robot or production machine can be adjusted depending on the processing of the drive system. Mechanics refers e.g. to its rigidity, elasticity, the bearing capacity of bearings, etc. In one embodiment of the method the load of at least one of the axes is consequently used for dimensioning of the machine tool or robot or production machine.

In one embodiment of the method a cycle of a machine, in particular of a machine tool, a robot or a production machine, is simulated, wherein the simulated actual value is an average value, wherein the dimensioning of the machine is changed depending on the average value. A cycle refers in particular to a recurring motion sequence of the axes of the machine. The average value refers for example to a torque of a drive of an axis. The average value allows in particular a thermal evaluation of the cycle.

In one embodiment of the method a typical NC program for production of an object is specified, from which it is then possible to specify the drive needed in order to perform the machining described in the NC program faster on a new machine. In addition, the quality of the production or machining can also be considered depending on the speed.

In one embodiment of the method an acceleration curve can be checked or calculated for a production cycle in order to draw conclusions from this regarding motor heating in an axis e.g. in the x-axis.

In one embodiment of the method a machining of spectacle lenses using linear direct drives can be examined, for example, in order through simulation to calculate the required acceleration or the jerk, in order therefrom to draw conclusions about the motor.

For example, also in the case of a gantry-type milling machine or a contour milling machine, with conventional dimensioning, the max. acceleration data assumed in the motor configuration cannot be achieved operationally (this affects the load) as a result of significant jerk limits in the axes (this affects the drive profile, as the virtual machine can be reflected there). The simulation of the virtual machine allows the max. achievable jerk values to be calculated and considered in the motor dimensioning. Saving motor power and cooling power creates great potential to save costs.

For example, machining on a milling machine with direct drives can result in the linear motors overheating and consequently in the failure of the drives in the x-axis. With the aid of the virtualization of the production or production machine (in this case the milling machine) using virtualization of the direct drives, it is possible to check whether the specified motion profile of the part program, which can be represented by a drive profile, caused the overheating. One or many of the following steps can be performed for this purpose:
Simulation of the part program using the machine data set for the NC controller;
Calculation of the target trajectories in respect of position, speed, acceleration and/or force, and/or
On the basis of the trajectories and/or on the basis of one or more motor models, calculation of the temperature curve in the motor during execution of the specific part program.

In one embodiment of the method simulated actual values are used to change the drive profile. The drive profile or a production can be adjusted e.g. for existing hardware (e.g. motor and/or current converter). Here, an adjustment for the possibilities or power limits of existing hardware can be performed e.g. by reducing an acceleration, in particular so that a drive's current limit is not exceeded.

In one embodiment of the method the drive system has a large number of axes. The drive system refers to a numerically controlled machine tool with multiple axes (e.g. with three, four, five or more axes), for example. The simulation and any adjustments that may be necessary can avoid, for example, an axis dimensioned too weakly reducing the performance of a whole drive system.

In one embodiment of the method a load of at least one axis is simulated. The axis has at least one motor or at least one motor-current converter combination.

By means of digitalization, simulation, or the provision of a digital twin, it is possible to determine and optimize the drive load for typical applications. Before the development of a new machine, the load of the axes can also be simulated in this way for a typical application. With this, the drive dimensioning and kinematic properties of the machines can be optimized.

In one embodiment of the method machine parameters are used for the simulation. By way of example, this is a transmission ratio for a transmission and/or an axis pitch, etc. The simulation is improved as a result.

In one embodiment of the method mechanical properties are used for the simulation. By way of example, this is a friction, a friction coefficient and/or a temperature coefficient, etc. The simulation is improved as a result.

In one embodiment of the method a machine parameter and a mechanical property are used for the simulation. This also improves the simulation.

In one embodiment of the method the comparative value is a maximum torque, a maximum rotational speed, a maximum power, a maximum current and/or a motor characteristic curve.

In one embodiment of the method a cycle is simulated, wherein the cycle undergoes thermal evaluation in particular. The cycle is, for example, a machining cycle, a production cycle, a load cycle, etc. By examining a cycle or by examining cycles it is possible to achieve an optimization of the load. During the drive dimensioning of a new machine, for example, a load cycle is estimated that is expected to represent the greatest load for one or more drives. It is now possible to perform the dimensioning using a part program and the machine-specific kinematic components. In 5-axis or 6-axis machining in particular, the highly dynamic compensating motions that occur make it difficult to estimate an appropriate load cycle.

In one embodiment of the method it is determined by means of the simulation which axis and which dynamic variable is having a limiting effect on dynamics during the sequence of the part program. The axis in question is changed in order to overcome the limit.

In one embodiment of the method it is possible to examine the extent to which a limit determined, or a large number thereof, is a decisive factor for the productivity of the machine. Simulation makes it possible to establish how extending the current limits would positively affect the manufacturing quality or the duration of the manufacturing process. If, for example, the acceleration limit in one axis could be increased by just a few percent, this can have a significant effect on the total machining time. This will then be implemented through machine construction and technical control measures. Here one step is, for example, identifying the relevant limit and establishing the relationship. This is made possible by means of the examinations shown. For example, it would be possible to proceed as follows:
Determine the drive load using a simulation
Perform at least one or more optimization options in:
   the drive and motor dimensioning
   the kinematic parameters
   the clamping situation
Automatically determine the limiting axis or the limiting variable.

In one embodiment of the method a torque-rotational speed diagram is created for a machine tool with five or more interpolated axes. From this it is possible to determine which axis is having a limiting effect.

In one embodiment of the method a histogram of dynamic limits is created. From this it is possible to determine what is limiting the dynamics, and countermeasures can be taken. For example, a higher-powered motor can be used.

In one embodiment of the method the drive dimensioning, the motor dimensioning, kinematic parameters and/or the clamping situation is optimized. As a result it is possible to raise efficiency.

In one embodiment of the method the limiting axis and/or a limiting variable are determined for a large number of axes. The limiting axis or the limiting variable can subsequently be analyzed and parts of the machine adjusted so that the limit identified no longer occurs.

In one embodiment of the method the drive load for a specific part program can be determined automatically using the parameters of the machine, by means of a simulation. In this case, exclusively the load due to the reference variables is examined in particular (disturbance variables such as e.g. machining forces and friction are disregarded). This result can represent a good approximation of the real total load.

In one embodiment of the method a load cycle is compared on a drive-by-drive basis with the characteristic curves and limits of the power section and motor. This refers, for example, to:
Maximum torque
Maximum rotational speed
Maximum power
Maximum current
Maximum force
Maximum speed
S 1 characteristic curve.

In one embodiment of the method a value for productivity and/or a value for manufacturing quality are determined. In the case of a robot as well as a machine tool, raising productivity can refer to an increase in the maximum possible speed of a motion system with multiple axes. In the case of a machine tool, manufacturing quality can refer to, for example, the surface quality of a workpiece being machined by means of a tool. As such, an increase in speed can cause a deterioration in manufacturing quality.

In one embodiment of the method it is possible to examine the extent to which the limits determined, in particular on axes or their drives, are a decisive factor for the productivity of the machine. Simulation makes it possible to trial how extending the current limits would positively or negatively affect the manufacturing quality or the duration of the manufacturing process. If, for example, the acceleration limit in one axis could be increased by just a few percent, this can have a significant effect on the total machining time. This can then be implemented through machine construction and/or technical control measures. In one step before optimizing (improving) the machine (machine tool, robot, production machine, etc.) the relevant limit is identified and the relationship is established. This is made possible by means of the examinations or simulations shown.

The trialing process can be automated. This means that iteration steps for optimization can be or are automated. In particular, for this purpose the manufacture of a workpiece is also simulated. The simulation considers which tool is intended for machining of the workpiece (e.g. type of milling head, type of drill bit, wear on the tool, etc.).

A drive system, which is a machine tool or a production machine in particular, has at least one axis, wherein a simulated load of the drive system is correlated with comparative values on the basis of a drive profile. Overloads and/or deficiencies, for example, can be identified in this way.

In one embodiment of the drive system, the drive system can be operated in accordance with the method described.

In one embodiment of the drive system, the drive system has a simulation computer that is linked by data connection via the internet to the machine tool or production machine. Computing work involving considerable effort can then be carried out remotely so as not to influence the machine's performance impermissibly.

In one embodiment of the drive system, the drive system has a large number of simulation computers, wherein one computer is provided in order to link up simulation data of the large number of simulation computers. This network structure allows the efficiency of the simulation to be improved.

The invention is explained in more detail below with reference to exemplary embodiments. In the drawings:

FIG. 1 shows a load cycle of a Z-axis of a machine;

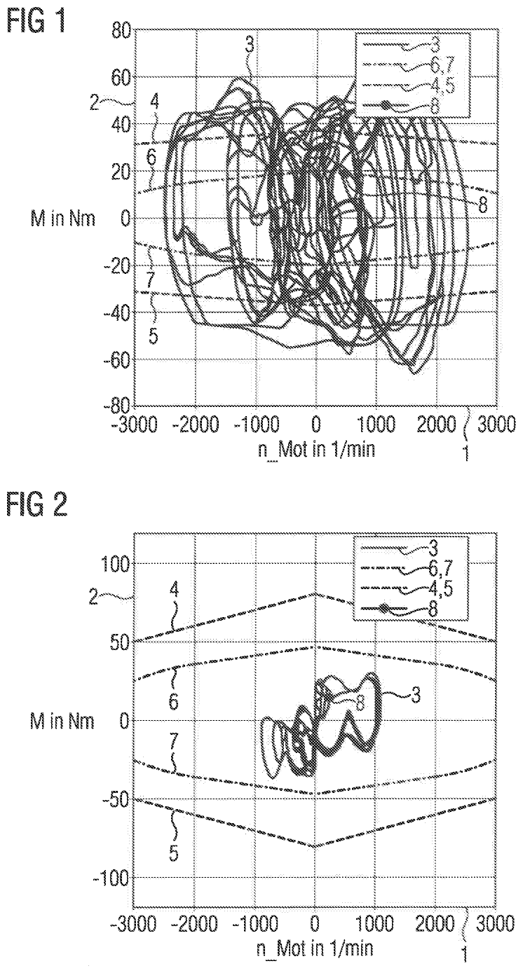

FIG. 2 shows a load cycle of a Z-axis of a machine;

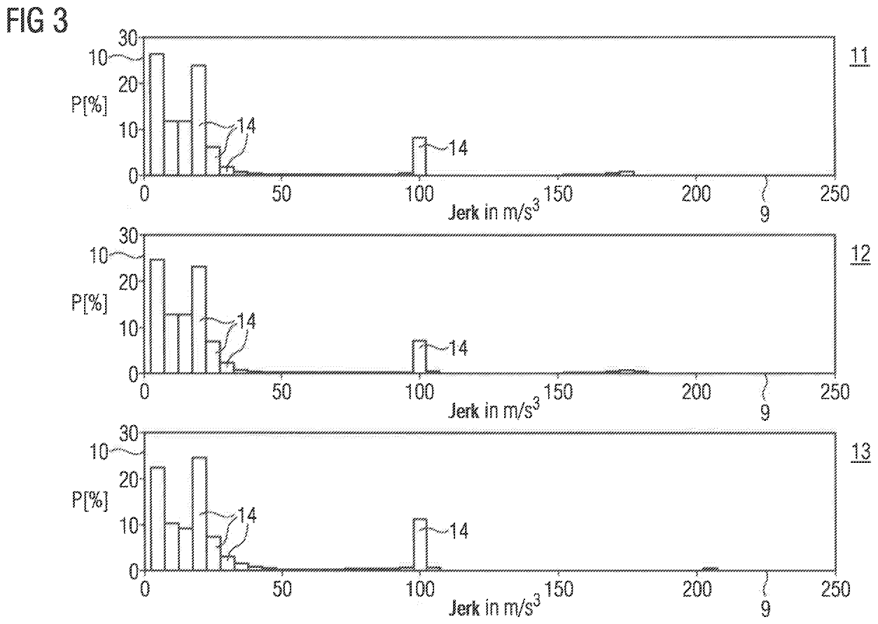

FIG. 3 shows a jerk of the axes X, Y and Z of a machine;

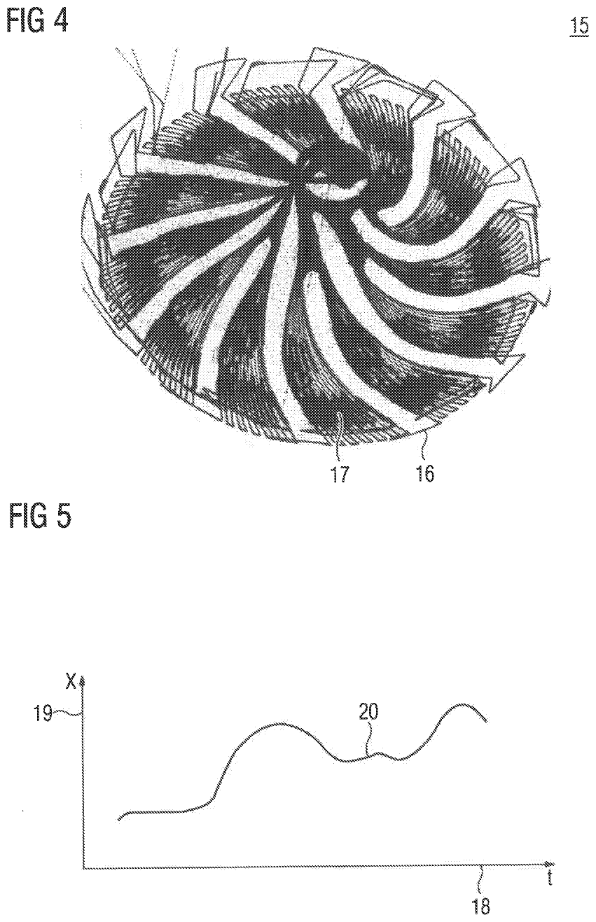

FIG. 4 shows a 3D representation of a contour traveled;

FIG. 5 shows a drive profile;

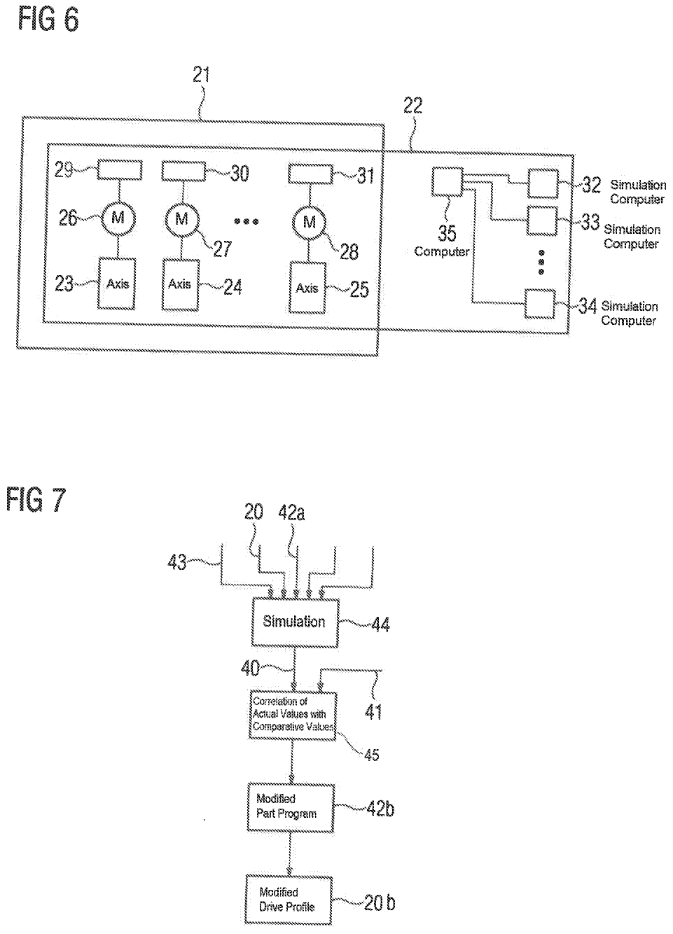

FIG. 6 shows a machine; and

FIG. 7 shows simulation steps.

FIG. 1 shows by way of example a load cycle 3 of a z-axis during the machining of an impeller wheel, wherein the load cycle relates to an accelerating torque on the z-axis. The rotational speed n_Mot of a motor in 1/min is plotted on an abscissa. An accelerating torque M in Nm is plotted on an ordinate 2. At no point in the cycle are the characteristic curves and limits of the motor and power section violated. The limit curves for torque, power and rotational speed lie outside the range shown. The point 8 for effective torque represents the average point in the cycle and is relevant for the thermal evaluation of the cycle. An upper S1-100K line 6 and a lower S1-100K line 7 are shown. Because the point 8 lies directly on the upper S1-100K line 6, the dimensioning is thermally critical and the use of a different motor should be considered. An upper S3-25% line 4 and a lower S3-25% line 5 are also shown, which are not violated.

Continuing on from FIG. 1, FIG. 2 shows a further curve 3 showing the load cycle of a Y-axis associated with the X-axis of FIG. 1 during the machining of the impeller wheel. At no point in the cycle are the characteristic curves and limits of the motor and power section violated. The limit curves for torque, power and rotational speed lie outside the range shown. The cycle is also non-critical thermally because the point 8 lies inside the range specified by the characteristic curves 4, 5, 6 and 7.

FIG. 3 shows as a percentage the frequency of occurrence of a jerk along three axes: X 11, Y 12 and Z 13. The magnitude of the jerk is plotted on the abscissa 9 in m/s³. Plotted on the ordinate 10 is in each case the percentage frequency P of occurrence of the jerk as a function of its strength. On the basis of a simulation, axes and their dynamic variables (jerk, acceleration or speed) can be determined. Using the simulation it is then possible to determine which axis and which dynamic variable (jerk, acceleration or speed) is having a limiting effect on dynamics during the sequence of the part program. A suitable representation can be produced e.g. as a histogram, as shown with an example in FIG. 3. According to the representation, columns 14 show that in many cases the jerk of the Z-axis is having a limiting effect. Different clamping situations, for example, can also be compared very easily with this method. In 5-axis machining, the Cartesian axes must additionally apply the compensating motions. Invisible path dynamics can cause highly dynamic compensating motions because of kinematics. The relationship between limits and machining time is non-trivial and difficult to evaluate. The representations described above can help in this regard:
Torque-rotational speed diagram for e.g. five axes (not shown)
Histogram of the dynamic limits e.g. over five axes (not shown).

FIG. 4 shows a 3D representation 15 of a contour traveled in a workpiece coordinate system. It is also possible for example to overlay colors in a three-dimensional representation of the contour traveled in the workpiece coordinate to represent which axis is having a limiting effect at the point indicated. A first green curve 16 represents, by way of example, the contour traveled in the workpiece coordinate system, wherein points or surfaces 17 where a c-axis is having a limiting effect are marked in red. Here the c-axis represents an axis of rotation of a machine tool.

FIG. 5 shows a drive profile 20. A time t is plotted on an abscissa 18 and a route x is plotted on an ordinate 19.

FIG. 6 shows a machine 21, which has at least part of the drive system 22. The machine 21 is a machine tool, for example. The drive 22 has a first axis 23, a second axis 24 and a third axis 25. A motor 26, 27 and 28 is assigned to each of the axes 23, 24 and 25 for the purpose of driving. A current converter 29, 30 and 31 is assigned to each of the motors 26, 27 and 28 in order to supply each motor 26, 27 and 28 with electrical energy. The drive system 22 has a large number of simulation computers 32, 33 and 34, wherein one computer 35 is provided in order to link up simulation data of the large number of simulation computers 32, 33, 34. After the simulation and the automatic assessment, in particular the identification of overloads, the drive system and/or also a part program can be modified automatically (e.g. with more powerful drives) such that the overall performance capability of the drive system increases.

FIG. 7 shows simulation steps, wherein in accordance with the simulation 44 simulated actual values 40 are correlated with comparative values 41. By way of example, data from a part program 42a, machine parameters 43 and/or a drive profile 20a are used for the simulation. After the assessment, the part program 42b can be modified automatically so that after a further simulation the limit values are exceeded at least to a lesser extent. Modifying the part program 42b also results in another drive profile 20b.

1.-17. (canceled)

18. A method for the assessment of a drive system for dimensioning of a machine tool or of a robot, said method comprising:
simulating actual values of the drive system with a drive profile;
correlating the simulated actual values with comparative values;
simulating a load of at least three axes of the drive system; and
determining from the simulation of the load which of the at least three axes and which dynamic variable has a limiting effect on dynamics as a part program is executed.

19. The method of claim 18, wherein the drive profile is based on the part program.

20. The method of claim 18, further comprising changing the drive profile in response to the simulated actual values.

21. The method of claim 18, wherein a load on the at least one of the axes is used to dimension the machine tool or robot.

22. The method of claim 18, wherein the simulated actual values are average values obtained during a single cycle of the machine tool or robot; and further comprising
changing dimensioning of the machine tool or robot in dependence on the average value.

23. The method of claim 18, wherein machine parameters are used for simulating actual values of the drive system.

24. The method of claim 18, wherein the comparative values comprise values selected from the group consisting of a maximum torque, a maximum rotational speed, a maximum power, a maximum current, a maximum speed, a maximum force, and a motor characteristic curve.

25. The method of claim 18, further comprising:
simulating a single operating cycle of the machine tool or robot; and
thermally evaluating characteristic properties of the single operating cycle.

26. The method of claim 18, further comprising establishing a torque-rotational speed diagram for a machine tool or robot having five or more interpolated axes.

27. The method of claim 18, further comprising establishing a histogram of dynamic limits.

28. The method of claim 18, further comprising determining a value related to productivity of the machine tool or robot, or a value related to manufacturing quality of the machine tool or robot.

29. The method of claim 18, further comprising:
determining an axis or a variable limiting of the at least three axes that limits performance of the machine tool or robot; and
optimizing drive dimensioning, motor dimensioning, kinematic parameters or a clamping situation.

30. A drive system, in particular of a machine tool or a production machine, said drive system comprising at least one axis, wherein a simulated load of the drive system is correlated with at least one comparative value on the basis of a drive profile, wherein the drive system is configured to execute a method as set forth in claim 18.

31. The drive system of claim 30, further comprising a simulation computer linked by data connection via the Internet to the machine tool or production machine.

32. The drive system of claim 30, further comprising:
a plurality of simulation computers linked by data connection via the Internet to the machine tool or production machine and generating simulation data; and
a computer operably connected to the plurality of simulation computers to link up the simulation data of the plurality of simulation computers.

33. A drive system, in particular of a machine tool or a production machine, comprising
at least three axes, and
a simulation computer configured to
simulate actual values of the drive system with a drive profile;
correlate the simulated actual values with comparative values;
simulate a load of the at least three axes of the drive system, and
determining from the simulation of the load which of the at least three axes and which dynamic variable has a limiting effect on dynamics as a part program is executed.

34. The drive system of claim 33, wherein the simulation computer is linked by data connection via the internet to the machine tool or production machine.

35. The drive system of claim 33, comprising:
a plurality of simulation computers linked by data connection via the Internet to the machine tool or production machine and generating simulation data; and
a computer operably connected to the plurality of simulation computers to link the simulation data from the plurality of simulation computers.
